(19) United States
(12) Patent Application Publication
(10) Pub. No.: US 2026/0091522 A1
(43) Pub. Date: Apr. 2, 2026

(54) FOLDING KNIFE BLADE ENGAGEMENT LOCK

(71) Applicant: Andrew Demko, Wampum, PA (US)

(72) Inventor: Andrew Demko, Wampum, PA (US)

(21) Appl. No.: 18/901,765

(22) Filed: Sep. 30, 2024

(51) Int. Cl. B26B 1/04

(52) U.S. Cl. CPC B26B 1/044

(57) ABSTRACT

A folding knife having a blade pivoted from a closed position to a manual release open locked position with a combined apertured sliding release and locking arm. The sliding release and locking arm is mounted within the knife handle on a fixed guide pin within an arm opening being spring urged there against. Arm positioning pins extends in oppositely disposed relation to one another from the locking arm providing dual frame engagement within respective guide slots therein. Arm positional projections are engaged on a modified blade shank during operation moving the locking arm back and up then releasing to slide forward locking the blade in auto open use position until manual arm engagement by the user against the arm spring and blade spring for release and transitional closure. Arm access operation is available secondarily via pin access opening in the exterior handles for alignment operation.

### BACKGROUND OF THE INVENTION

### 1. Technical Field

This invention relates to folding pocket type knives that have locking mechanisms to hold the knife blade in open locked use position or in folded closed non-use position. Such locking mechanisms are referred to as locking bars or pin configurations.

### 2. Description of Prior Art

Prior art folding knives have been developed with a variety of blade locking engagement structures to afford numerous blade lock and release positions, see for example U.S. Pat. Nos. 4,837,932, 6,574,869 and 6,591,504, 10,632,632 and 11,220,013.

In U.S. Pat. No. 4,837,932, a locking blade pocket knife is disclosed having a beam spring with a retractable locking member with a ratchet tooth, cam guide and engaging the tang portion of the knife blade controlling movement.

U.S. Pat. No. 6,547,869 claims a folding pocket knife with a lock having a sliding lock element with a pin projection that engages the blade preventing unlocking from the open position unintentionally.

U.S. Pat. No. 6,591,504 shows a folding knife with a safety lock movably mounted on its handle for a lock to unlock position.

Applicant's U.S. Pat. No. 10,632,632 discloses a folding knife with a sliding release and locking arm engaging the blade shank in closed and open locked positions.

U.S. Pat. No. 11,220,013 claims a folding knife blade with a spring urged release locking arm to open and close the knife blade and a guide pin to maintain the locking arm's longitudinal repositioning.

### SUMMARY OF THE INVENTION

A folding knife opening and locking device having a spring urged self-repositioning safety lock and release arm that is engaged by the blade shank and frame as it opens being repositioned thereby in longitudinal and arcuate travel paths. User locking and release arm initiation is required to unlock from open position releasing blade and the spring slidable dual action self-locking arm. Multiple arm to blade shank engagement points define blade open lock position and corresponding blade locked retainment in closed position with continuous intermediate positioning by repositioning the locking arm via an arm positioning pin in a contoured guide in the frame.

### DESCRIPTION OF THE DRAWINGS

FIG. 1 is an enlarged partial side elevational view of a safety lock folding knife of the invention in open blade locked position with portions broken away.

FIG. 2 is an enlarged partial side elevational view thereof in blade closed position.

FIG. 3 is a partial exploded perspective assembly view of the safety locking folding knife in blade open position.

FIG. 4 is an enlarged side elevational view of the safety locking folding knife in open locked position and partial blade in unlock position in broken lines.

FIG. 5 is a top plan view thereof.

FIG. 6 is an enlarged side elevational view of a knife frame element with a locking arm guide opening therein.

FIG. 7 is an enlarged partial side elevational view of the locking arm engaged in a guide frame element opening in locked open position.

FIG. 8 is an enlarged partial side elevational view thereof in unlocked position.

FIG. 9 is an enlarged perspective view of a safety locking arm.

FIG. 10 is an enlarged top plan view thereof.

FIG. 11 is an enlarged side elevational view of an alternate locking arm configuration.

FIG. 12 is an enlarged side elevational view of a second alternate locking arm configuration.

FIG. 13 is an enlarged rear side elevational view thereof.

FIG. 14 is an enlarged side elevational view of the knife handle element of the second alternate form.

FIG. 15 is an enlarged side elevational view of the alternate locking arm.

### DETAILED DESCRIPTION OF THE INVENTION

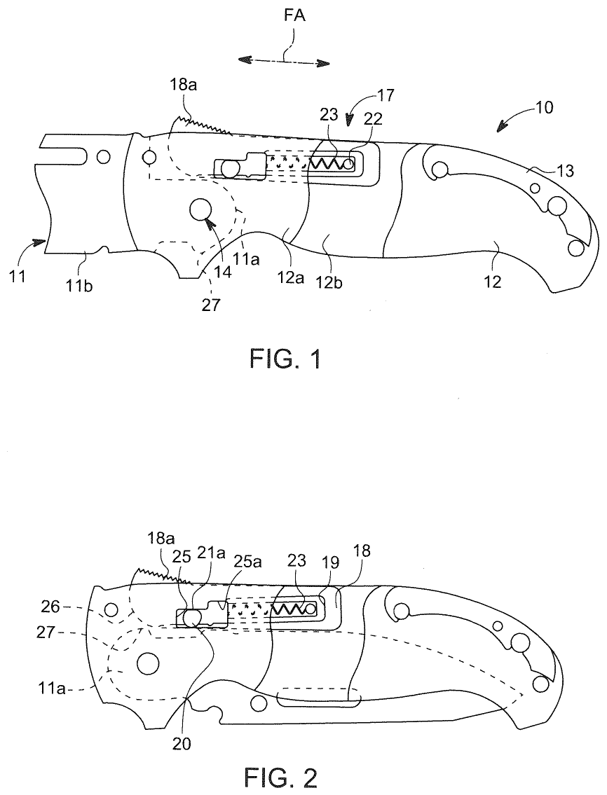

Referring to FIGS. 1 and 2 of the drawings, a folding knife 10 of the invention can be seen in its unfolded and folded locked positions. The knife 10 has a blade 11 pivotally secured within handle portions 12 with an end handle support spacer 13 secured there between. The blade 11 is pivotally secured between respective frame handle portions 12A and 12B by a hinge pin fitting 14 therethrough for displacement which defines an opening and closing folding knife configuration. The blade 11 has a shank 11A with an extending blade body 11B.

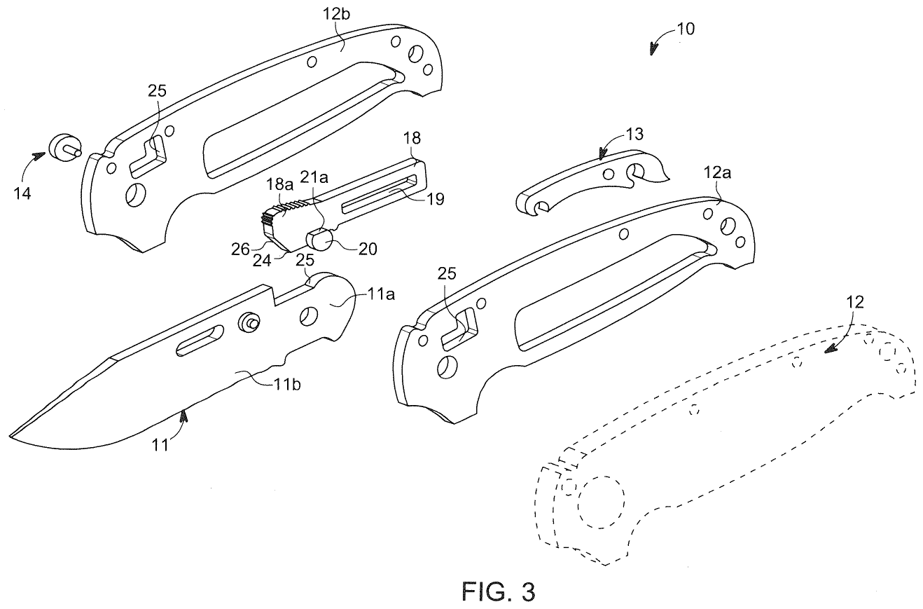

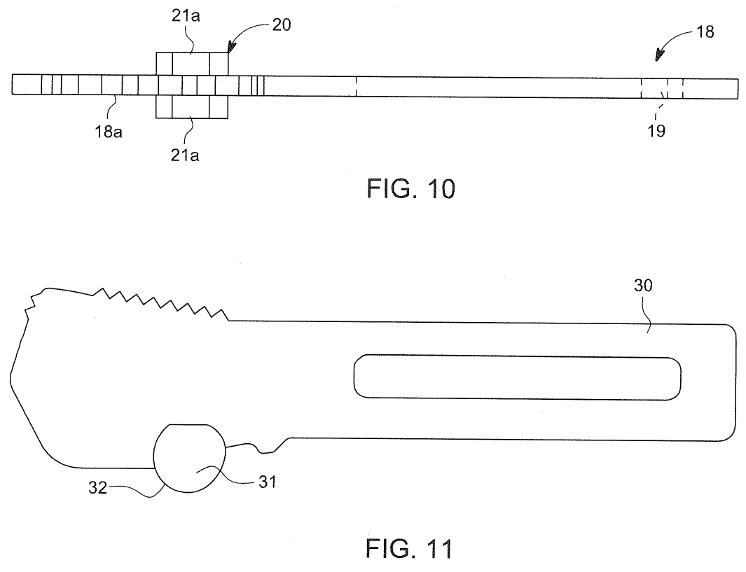

A safety release locking arm assembly 17 of the invention is movably positioned within the frame handle portions 12A and 12B to and from open blade lock position and closed blade retainment position illustrated in FIGS. 1 and 2 of the drawings respectively. The safety release locking arm assembly 17 has an apertured locking and release arm 18 with an elongated repositioning retainment slot 19 therein. A locking arm repositioning pin 20 extends from both sides of the arm 18 adjacent the slot 19 having an annular surface 21 with an upper flat frame engagement portions 21A, best seen in FIGS. 3, 7, 8, and 10 of the drawings.

The safety auto release locking arm assembly 17 is movably retained within and between the frame handle portions 12A and 12B by the arm repositioning pins 20 and a fixed guide pin 22 extending from the handle. The arm repositioning pins 20 are registerable within a contoured guide slots 20A in the respective frame handle portions 12A and 12B. The fixed guide pin 22 is received within the arm slot 19 in the locking arm 18 with an arm spring 23.

A resilient arm spring 23 is retained within the elongated retainment slot 19 against the fixed guide pin 22 thus urging the locking release arm 18 towards the blade shank 11A for selective engagement therewith during the blade range of motion as will be described in detail hereinafter.

It will be seen that the locking arm 18 upper surface has an upstanding tapered and textured portion 18A which acts as and extends from between the frame handle portions 12A and 12B and handles 12 for user engagement during use.

A lower end surface of the locking arm 18 has a contoured blade selective shank engagement portion 24 which defines the portion of the arm 18 for direct engagement with the blade shank 11A in blade open lock position, as best seen in FIG. 1 of the drawings. A tapered end arm surface 26 of the arm 18 is correspondingly in direct blade shank 11A engagement when in closed position as seen clearly in FIG. 2 of the drawings. Correspondingly, the locking arm positioning pins 20 are registerable within the frame elements 12A and 12B, contoured slot 25 providing for enhanced blade stabilization in both blade open lock and blade closed position as seen in FIGS. 1, 2, 7 and 8 of the drawings. The positioning pins 20 flattened upper surface 21A provides positive surface to surface engagement with the corresponding upper inner surface 20B of the pin receiving guide slots 25. It will also be evident that during blade 11 repositioning that the arm positioning pins 20 and locking arm 18 will move laterally and vertically as the arm 18 is engaged by the blade shank 11 from open to closed position as illustrated in FIGS. 1, 2 and 8 of the drawings.

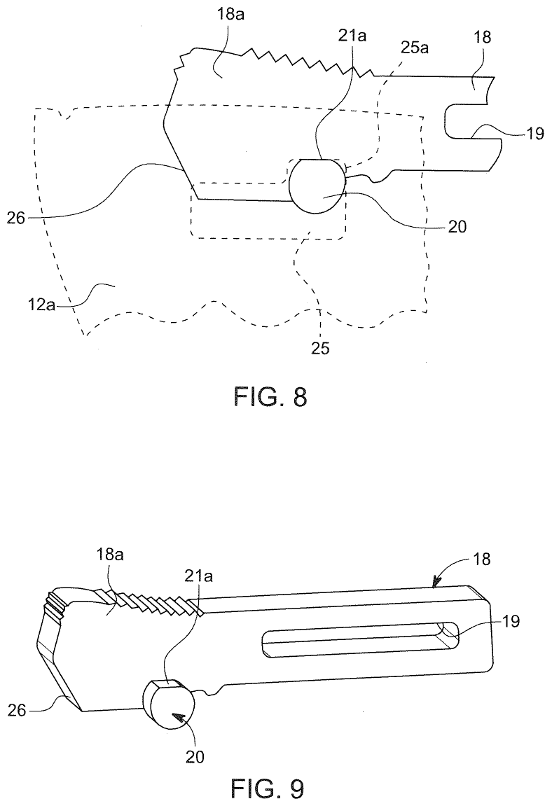

It will therefore be seen that in use from a closed folded position shown in FIG. 2 of the drawings, the blade 11 is held in place, under tension, within the frame handles 12A and 12B by the spring urged locking retainment activation arm 18 engaged against a blade shank 11A retainment portion 27 and the arm positioning pins 20 registration with the contoured guide slots 25. Upon user engagement, not shown, blade deployment is activated by sliding the locking arm 18 back against the spring 23 as shown in broken lines in FIG. 1 of the drawings releasing the blade 11 for opening to a locked open position. As the blade shank tab 11A rotates, it will simultaneously lift the locking arm 18 which is accomplished due to the contoured depending portion 24 and the increased dimension of the guide slots 25 at 25A as seen in FIG. 8 of the drawings as the surface of the arm 18 travels along the radial end of the shank 11A with the arm positioning pin 20 within the contoured frame guide slots 25.

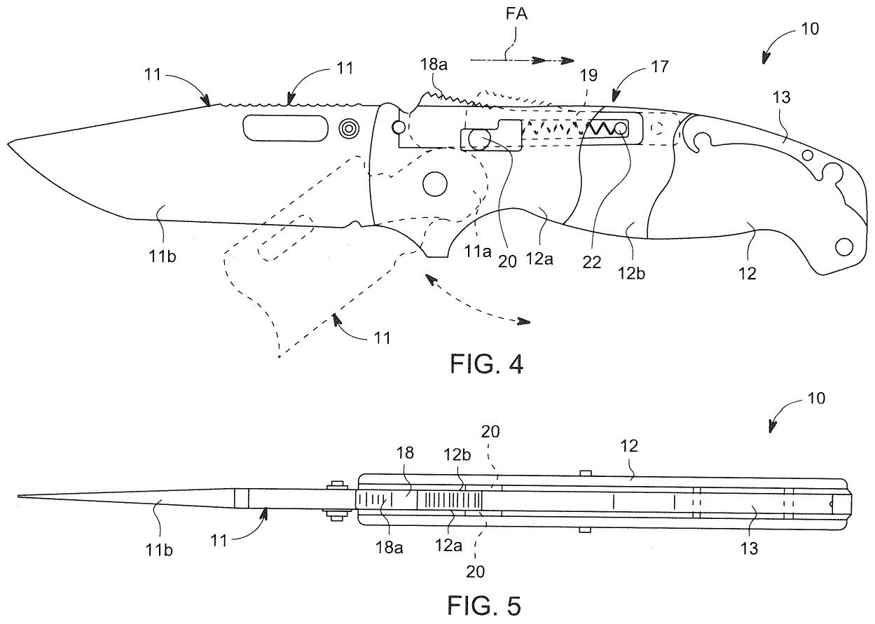

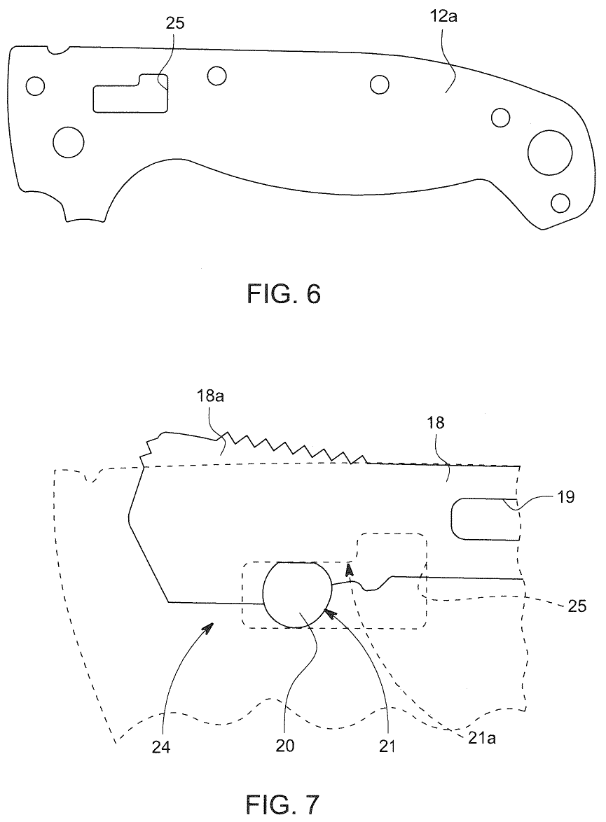

Once the blade 11 reaches full open position as illustrated best in FIGS. 1 and 4 of the drawings, the locking arm 18 slides back under spring 23 tension and locks the blade 11 in open position. The arm's 18 tapered blade shank engagement portion is engaged as described on the shank's engagement portion 27. Correspondingly, to close the knife the user, not shown, will engage the locking arm's 18 upper engagement surface 18A sliding it back against the spring 23 tension, releasing the blade 11 illustrated by directional force arrow FA thus releasing the blade shank 11A and the blade 11 allowing it to be pivoted down into the closed locked position in FIG. 4 in broken lines and FIG. 2 of the drawings.

It will therefore be apparent from the above-described operational action that the folding knife 10 of the invention with the safety release locking arm assembly 17 with locking release arm 18 achieves multiple actionable locking arm to blade and blade shank and positional frame engagement via the arm positioning pins 20 in a selective controlled contact and locking engagement positions to define a unique opening safety lock arm assembly for a folding knife.

Referring to FIG. 11 of the drawings, an alternate locking and release arm 30 can be seen having revised arm positioning pins 31 defined by continuous annular surfaces 32 there about so as to be registerable within the hereinbefore described guide slot 25 with the same registration engagement as hereinbefore described for the guide pin 20.

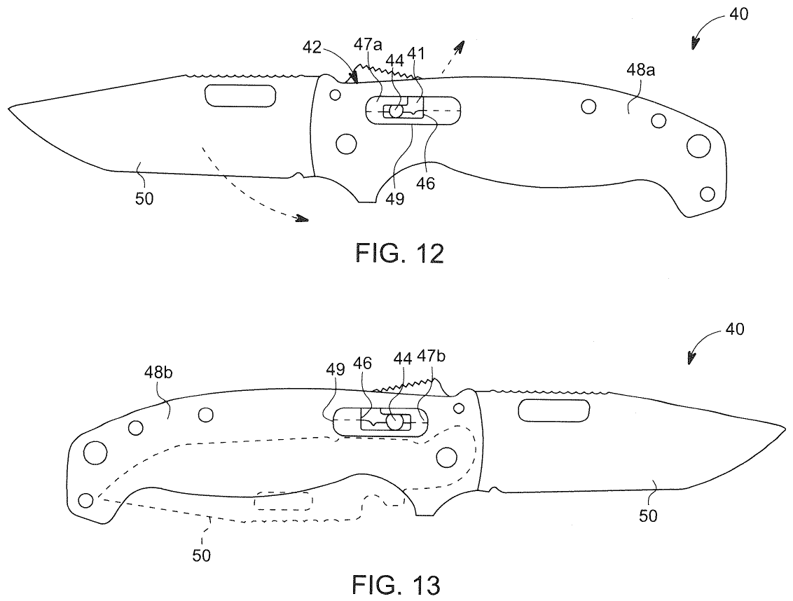

Referring now to FIGS. 12, 13, 14 and 15 of the drawings, a second alternate folding knife 40 can be seen with an engagement locking arm 41 having a revised locking and release arm assembly 42. The alternate locking arm 41 has an elongated slot 43 therein. A pair of locking arm repositioning pins 44 extend from respective sides of the arm 41 adjacent the proximal end of the slot 43. Each of the repositioning pins 44 has an annular perimeter surface 45 with an upper flat frame engagement portion 45B, best seen in FIG. 15 of the drawings.

As in the preferred embodiment, the respective pins 44 are engaged within corresponding aligned contoured slots 46 in the respective frame handle portions 47A and 47B.

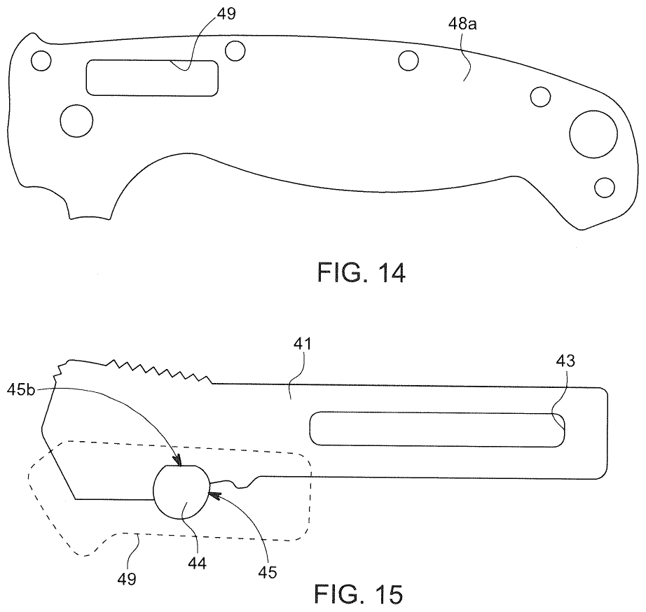

A pair of oppositely disposed exterior handles 48A and 48B are secured over the respective frame handle portions 47A and 47B, each having elongated contoured pin access opening 49 therein, best seen in FIGS. 13 and 14 of the drawings. The access openings 49 overlie the respective oppositely disposed repositioning pins 44 on opposite sides of the knife 40. It will be evident from the above description that given the aligned access openings 48A and 48B, the repositioning pins 44 can be engaged directly by the user, not shown, so as to provide lock pin release and engagement of the lock pin arm 41 to allow for repositioning independently of the original direct engagement of the locking arm 18 via its upper surface 18A as set forth in the preferred embodiment.

It will be evident that the action of a knife blade 50 is the same as in the preferred embodiment wherein the axial rotation from locked open position, as seen in FIGS. 13 and 14, to folded closed position, shown in broken lines in FIG. 13. The pins 44 engagement with respect of oppositely disposed guide slots 43 will function in the same manner as that of the hereinbefore described preferred embodiment of the invention upon the knife blade so axial rotation from an open lock position to a closed lock position, shown in broken lines in FIG. 12 of the drawings will be achieved.

It will further be evident that by allowing direct user access to the repositioning pins 44 on either side of the knife via the openings in the handles, it provides option wherein direct contact with the locking arm 41, as hereinbefore described, will not be necessary for indications and applications where its access may be not possible by maintaining the locking arm 41 within the confines of the handle, thereby providing a more streamlined configuration to the handle configuration with the recessed openings for direct access activation.

It will thus be seen that a new and useful opening folding arm locking knife has been illustrated and described and it will be apparent to those skilled in the art that various changes can be made therein without departing from the spirit of the invention. Therefore, I claim:

1. A folding knife comprises,
an elongated handle, an elongated knife blade having a sharp edge portion and an apertured shank portion,
said knife blade coupled within said handle for pivoted movement from a first closed retained position to a second opened locked position, frame handle elements within said handle having exterior handles thereon,
an apertured spring urged locking and release arm within said handle for engagement with said blade shank portion from said first closed retained position to said second blade release to open lock position, locking arm position pin on said locking and release arm registerable within respective openings in said handle frame elements,
a fixed guide pin registerable through said apertured locking and release arm,
tapered upstanding end portion surfaces on said locking and release arm,
a blade shank engagement portion depending from said locking and release arm, said locking arm positioning pins movable from a first blade retainment position to a second blade transition position within said respective openings in said handle frame elements.

2. The folding knife set forth in claim 1 wherein said frame handle elements have an end handle spacer there between.

3. The folding knife set forth in claim 1 wherein said apertured locking and release arm has a repositioning guide retainment slot for receiving said fixed guide pin and a spring there within.

4. The folding knife set forth in claim 1 wherein said blade shank portion has an arcuate end shank surface defining shank retainment portions when in locking arm engaged closed position and open position.

5. The folding knife set forth in claim 1 wherein said spring urged locking and release arm is slidably disposed within said handle portion from a blade closed lock position to a blade release position to a spring return blade open lock position against the blade shank portion after deployment of the blade.

6. The folding knife set forth in claim 1 wherein said locking arm positioning pins have an annular perimeter surface and a flat frame engagement portion thereon.

7. The folding knife set forth in claim 1 wherein said knife blade transition positioning comprises, a knife blade position midway between said knife blade open lock position and said knife blade closed position.

8. The folding knife set forth in claim 1 wherein said locking arm positioning pins have an annular frame engagement surface.

9. The folding knife set forth in claim 1 wherein said respective openings in said handle frame elements are contoured for locking arm positioning pins engagement from a first blade closed and open position to a second knife blade transitional position there between.

10. The folding knife set forth in claim 1 wherein said exterior knife handles have pin access openings therein aligned with said respective lock arm positioning pins for manual engagement.
